(19) United States
(12) Patent Application Publication
(10) Pub. No.: US 2009/0259469 A1
(43) Pub. Date: Oct. 15, 2009

(54) METHOD AND APPARATUS FOR SPEECH RECOGNITION

(75) Inventors: Changxue Ma, Barrington, IL (US); Yuan-Jun Wei, Hoffman Estates, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/102,141

(22) Filed: Apr. 14, 2008

(51) Int. Cl. G10L 15/00; G10L 15/02; G10L 15/06

(52) U.S. Cl. 704/246; 704/231; 704/250; 704/E15.008; 704/E15.001; 704/E15.039

(57) ABSTRACT

A method and apparatus for performing speech recognition receives an audio signal, generates a sequence of frames of the audio signal, transforms each frame of the audio signal into a set of narrow band feature vectors using a narrow passband, couples the narrow band feature vectors to a speech model, and determines whether the audio signal is a wide band signal. When the audio signal is determined to be a wide band signal, a pass band parameter of each of one or more passbands that are outside the narrow passband is generated for each frame and the one or more band energy parameters are coupled to the speech model.

### FIELD OF THE DISCLOSURE

The present disclosure relates generally to speech recognition and more particularly to speech recognition techniques for recognizing speech when audio signals of differing bandwidths may be required to be recognized.

### BACKGROUND

Speech recognition techniques have evolved to a point where they are used in many mobile communication devices, such as cellular phones carried by people or fixed in vehicles. However, the architecture of present techniques is such that a speech recognizer optimized for a wider band voice signal, such as one presented to the speech recognizer from a microphone, does not provide optimum performance when presented with a narrower band voice signal, such as one presented by a Bluetooth device. Present architectures could optimize performance for both types of signals, but would result in using two speech models and would require almost double the resources of one speech recognizer.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram that shows an environment within which a speech recognition system operates, in accordance with certain embodiments.

FIG. 2 is an electrical block diagram that shows a speech recognition system, in accordance with certain embodiments.

FIG. 3 is a flowchart that shows some steps of a method for speech recognition, in accordance with certain embodiments.

FIG. 4 is a flowchart that shows some details of a step of FIG. 3, in accordance with certain embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

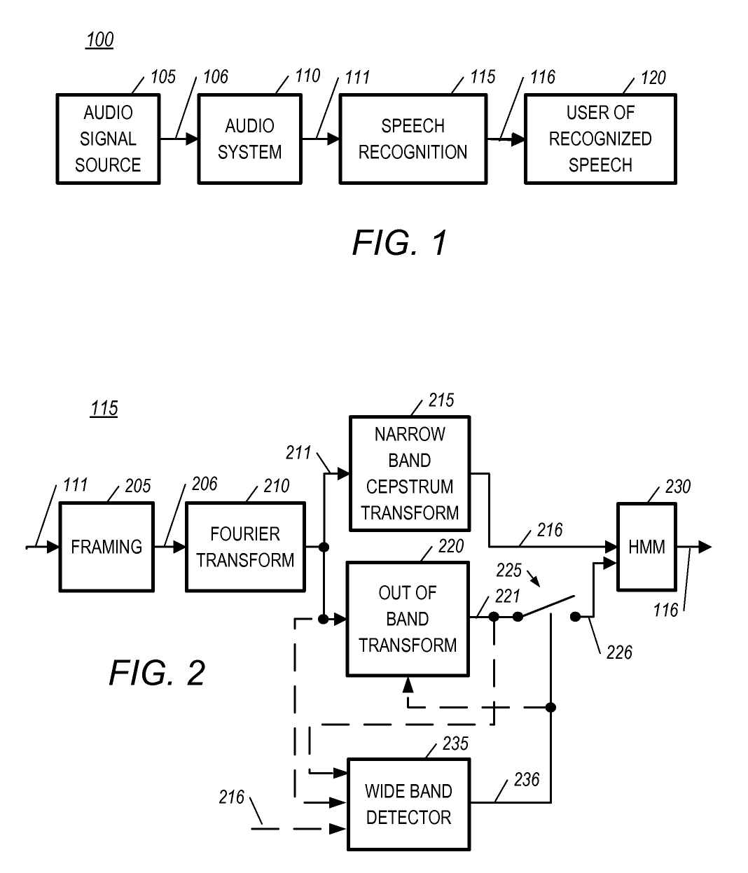

Referring to FIG. 1, a block diagram shows an environment 100 within which a typical speech recognition system 115 operates, in accordance with certain embodiments. An audio signal source 105 generates a source audio signal 106 which is coupled to an audio system 110. The audio signal source 105 is typically a human who is speaking. The audio system 110 conveys the source audio signal 106 to a speech recognition system 115, but in the process typically modifies the source audio signal thereby presenting an audio signal 111 to speech recognition system 115 that is different from the source audio signal 106. For example, the audio system 110 may be a Bluetooth speaker and microphone combination device that receives spoken audio and transmits it using the Bluetooth protocol in a radio frequency signal to a cellular telephone that receives Bluetooth radio frequency signal and converts it to an audio signal, or perhaps a digitized audio signal, that is coupled to the speech recognition system 115. In accordance with the Bluetooth protocol, the audio signal 111 is coupled to the speech recognition system 115 is relatively narrow band, having frequency components in a range from approximately 300 Hz to 3200 Hz. On the other hand, when spoken audio is received by a speaker built into the housing of a cellular telephone, the audio processing system within the cellular telephone calls an audio signal 111 to speech recognition system 115 that has a considerably wider bandwidth, for example from approximately 30 Hz to an upper frequency limit that is at or above approximately 4 kHz, and may be as high as approximately 8 kHz.

Similar situations may arise in other environments in which speech recognition is performed. For example a speech recognition system 115 may receive audio that has been passed through a telephone system that restricts the audio to a similarly narrow band, such as from approximately 300 Hz to 3200 Hz. The same speech recognition system 115 may also be intended to process audio that is not bandwidth limited and in fact may be conveyed through a microphone and audio system at present wideband audio extending from below 30 Hz to above 8 kHz to speech recognition system.

The speech recognition system 115 accepts the audio signal 111 coming from either type of audio system 110, that is to say a narrowband audio signal 111 or a wide band audio signal 111 and performs speech recognition using the minimized resources and optimal recognition techniques and presents the results to a user of recognized speech 120. The user of recognized speech 120 may be a function such as a contacts directory, a dialing function, a memo storage function, just to name a few. The speech recognition system 115 and user of recognized speech 120 may be implemented in a cellular telephone, a game box, a remote control such as a TV remote, or any other communication device that accepts voice audio.

Referring to FIG. 2, an electrical block diagram shows a speech recognition system 115, in accordance with certain embodiments. The speech recognition system 115 comprises a framing function 205 that accepts the audio signal 111, segments and shapes the audio signal 111 into frames 206, and couples the frames 206 to a Fourier transform function 210. The frames 206 may be generated as conventional frames for a speech recognition system. For example the frames 206 may have a duration that ranges from approximately 5 ms to 50 ms and a period of in a range from 5 to 15 msec (implying overlap in a typical system) in and may have some overlap and tapered ends. The Fourier transform function 210 may perform a conventional discrete fast Fourier transform over a frequency range that spans the widest bandwidth audio signal that the voice recognition system 115 is designed to reliably recognize. The Fourier coefficients 211 resulting from the Fourier transform are coupled to a narrowband cepstrum transform 215, are coupled to an out of band transform 220, and are optionally coupled, in certain embodiments, to wide band detector 235.

The narrowband cepstrum transform 215 performs a conventional cepstrum transform using components of the Fourier transform that are within the narrowband frequency range. The cepstrum transform 215 may be a conventional mel frequency cepstrum transform 215. When a conventional frequency cepstrum transform 215 is used, the logarithmic amplitudes of the Fourier transform within the narrow band are mapped onto a conventional mel frequency scale, using triangular overlapping windows. Then a discrete cosine transform is taken of the logarithmic amplitudes so obtained. The discrete cosine transform coefficients 216, commonly referred to as mel frequency cepstrum coefficients, or MFCCs, of which there are typically 13, are coupled to a speech model 230. First and second time derivatives of each MFCC may be determined, as in conventional speech recognition systems, and included with the MFCCs. When a narrow band signal is being processed, these 39 coefficients form a feature vector for each frame, which is calculated using the frequency components only within the narrow band, and is called herein a narrow band feature vector. In certain embodiments the speech model 230 is a hidden Markov model, or HMM, that has been trained as described below. Other Bayesian speech models could be used.

As noted above, the Fourier coefficients 211 are coupled to the out of band transform 220. The out of band transform 220 is set up to have one or more passband filters. Each passband filter selects Fourier transform coefficients within the passband to generate a band energy parameter for the passband. In certain embodiments each passband filter is triangular in shape. The center of each passband filter is outside the narrowband range. Each edge of each passband filter may overlap another passband filter, or may overlap frequency components that are within but near the edges of the narrowband frequency range. The generation of the band energy parameter for a passband comprises determining log(Eᵣᵢ/E) for each passband, wherein i is a passband index, Eᵣ is a relative energy of the passband, and E is the energy of the frame. The first and second derivatives are also used, so an energy parameter may comprise three values in certain embodiments. As noted above, one or more energy parameters 221 may be generated since one or more passband filters may be used. In one type of embodiment, the narrow passband range is from 312 Hz to 3062 Hz, and there are two triangular passband filters, one having a frequency range from 62 Hz to 312 Hz and another one having a frequency range from 3062 Hz to 3968 Hz. The six values for these two parameters may be synchronously combined with the 39 MFCCs for the same frame to form an expanded feature vector, in this case having 45 coefficients for each frame of a wideband audio signal, in accordance with certain embodiments.

The one or more parameters are coupled to a switch function 225, which is controlled by a signal 236 that closes the switch 225, coupling the passband parameters 221 to the speech model 230. The passband parameters 221 are coupled to the speech model 230 when a determination has been made that the audio signal 111 is a wideband signal. When such a determination has been made, the signal 236 may be coupled in certain embodiments to the out of band transform 220 to stop it from processing the out of band energy, thereby saving resources such as the energy that otherwise is used to perform the out of band transform, and, when the out of band transform is a computer process, the associated computer resources. The control signal is provided by a wide band detector function 235, which may use one or more signals 211, 221, and 216 to determine when the audio signal 111 is a wideband signal.

Signal 221 comprises the passband parameters determined by filtering and transforming the energy in each passband by the out of band transform 220 according the formula described above. This may be the only signal needed in certain embodiments to determine whether a wide band signal is present. Clearly, when this signal is used by the wide band detector 235, the out of band transform must remain active, so the coupling of control signal 236 to the wide band detector 220 would not be needed.

Signal 211, which includes the Fourier coefficients of the Fourier transform of the frame, may be used by the out of band transform 220 to evaluate those coefficients that are out of the narrow band frequency range. This is useful when it is concluded, during the design cycle, that the determination of the presence of a wideband signal is accomplished more reliably with some other transform of these Fourier coefficients than the one performed by the out of band transform 220, or is accomplished more reliably with some other transform of the Fourier coefficients in combination with the passband parameters 221.

Input signal 216 may be provided in certain embodiments as an information signal that indicates which type of signal the selected audio system provides: narrow band or wide band. When this input signal 216 is provided, the signals 211 and/or 221 are typically not needed and the signal 216 can basically be directly coupled to the switch function 225. In these embodiments, the out of band transform 220 can be deactived by, for example, the signal 236. In a cellular telephone equipped for Bluetooth as well as direct microphone input, the processing system typically stores a state indicating which of these is the source of audio that is being speech recognized. This state may be used as the signal 236 in certain embodiments.

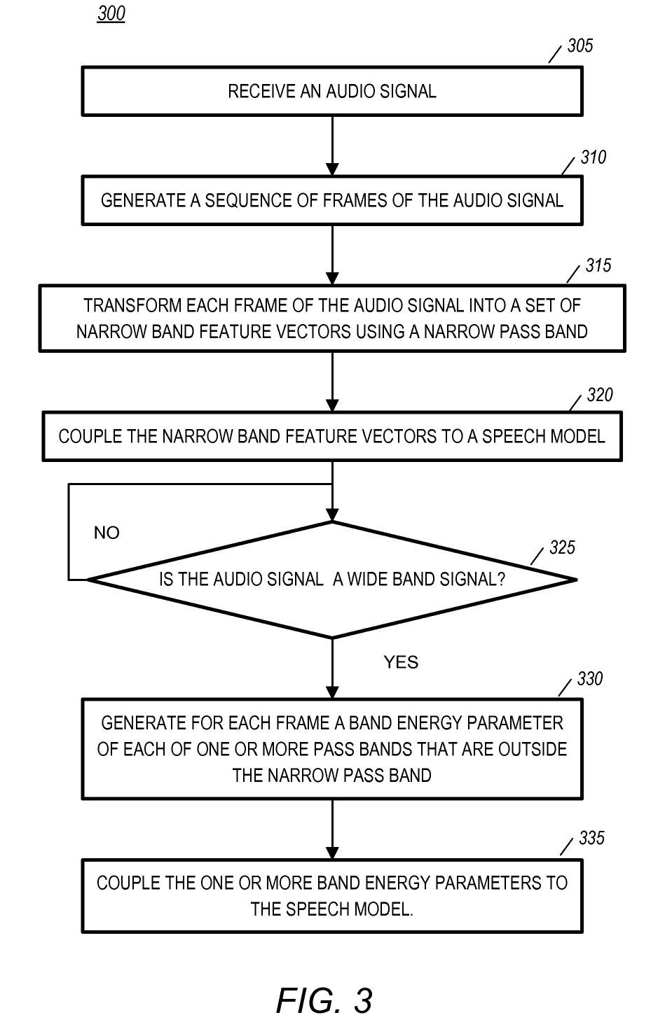

Referring now to FIG. 3, a flowchart 300 shows some steps of a method for speech recognition, in accordance with certain embodiments. At step 305, an audio signal (111, FIG. 2) is received by a speech recognition system (115, FIG. 2). At step 310 a sequence of frames (206, FIG. 2) is generated from the audio signal. Each frame of the audio signal is transformed into a set of narrow band feature vectors (216, FIG. 2) using a narrow passband at step 315. The transform performed by this step may be performed in certain embodiments by a combination of the Fourier Transform 210 and narrow band cepstrum transform 215 of FIG. 2. The narrowband feature vectors are coupled at step 320 to a speech model (230, FIG. 2). At step 325 a determination is made as to whether the audio signal is a wideband signal. When the audio signal is a wideband signal then a band energy parameter is generated at step 330 for one or more passbands of each subsequent frame that are outside the narrow passband. The generation of the band energy parameters performed by this step may be performed in certain embodiments by a combination of the Fourier Transform 210 and out of band transform 220 of FIG. 2. At step 335 new one or more band energy parameters are coupled to the speech model in frame synchronism with the narrowband feature vectors. When the audio signal is determined not to be a wideband signal at step 325, then the determination as to whether the audio signal is a wideband signal is performed again, either at each subsequent frame or at some other event that may indicate a possible change of audio signal type. In general, the steps described herein may be performed in accordance with the definitions and descriptions provided above with reference to FIG. 2. It will be appreciated that the steps of the method shown here need not be in the order shown. For example, the decision made at step 325 could be made instead after step 330.

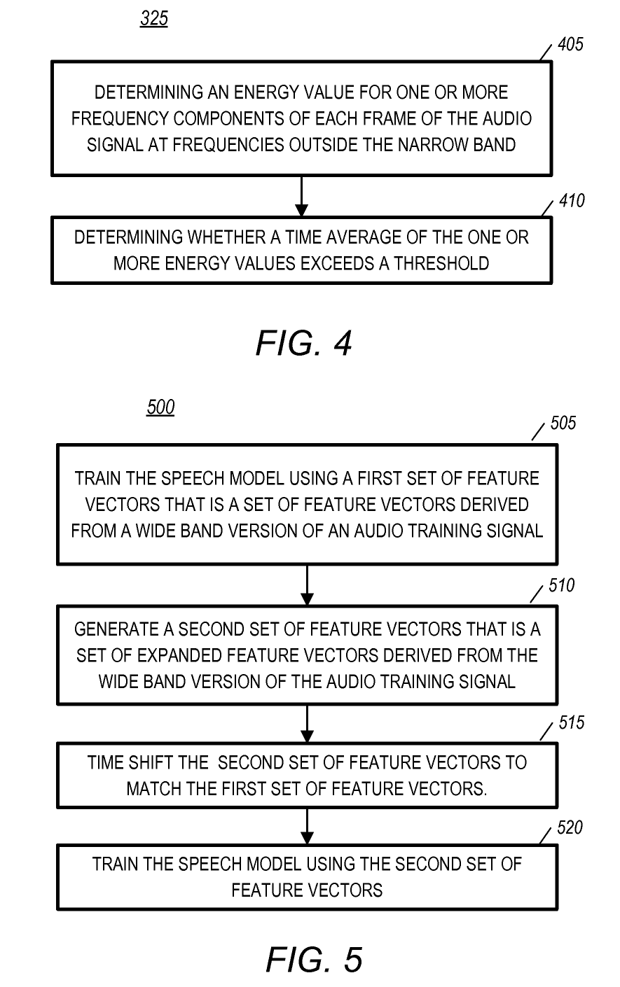

Referring to FIG. 4, a flowchart shows some details of step 325 (FIG. 3), in accordance with certain embodiments. At step 405, an energy value for one or more frequency components of each frame of the audio signal is determined at frequencies outside the narrowband. As explained above with reference to FIG. 2, the energy value may be based on the Fourier transform coefficients generated, for example, by the Fourier transform function 210 (FIG. 2) or based on the energy parameters generated by the out of band transform 220 (FIG. 2), or a combination of the two. At step 410, a time average of the one or more energy values may be updated at each frame or at some other event such as an end of a phrase or a system event such as a time interval. The time average is then evaluated to determine whether or a threshold is exceeded.

Referring to FIG. 5, a flowchart 500 shows some steps of a method for training a speech model, such as speech model 230 (FIG. 2), in accordance with certain embodiments. At step 505, the speech model is trained using a first set of feature vectors that is a set of feature vectors derived from a wideband version of a voice training signal, of which one example is a built-in microphone voice audio signal. In a system that processes Bluetooth voice audio or built in microphone audio, such as a cellular telephone, the wideband signal used for training may have a bandwidth of 0 Hz to 4000 Hz, and the set of vectors may be a set of 39 conventional mel frequency cepstrum coefficients and their derivatives. At step 510, a second set of feature vectors that is a set of expanded feature vectors derived from a wideband version of the voice training signal is generated. The second set of feature vectors is then time shifted at step 515 to match the first set of feature vectors. Then at step 520 the speech model is trained using the second set of feature vectors. When a speech model is trained by the method 500 and then used in a speech recognition system as described herein with reference to FIGS. 2-4, the speech recognition system performs highly reliable speech recognition using a single speech model and minimized system resources.

It will be appreciated that, although the embodiments described so far have been described in terms of a narrow band audio signal and a wide band audio signal, the techniques described are easily adapted by one of ordinary skill in the art to a speech recognition system that handles more than two band widths of audio signals.

It will be appreciated that some embodiments may comprise one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or apparatuses described herein. Alternatively, some, most, or all of these functions could be implemented by a state machine that has no stored program instructions, or in one or more application specific integrated circuits (ASICs), in which each function or some combinations of certain of the functions are implemented as custom logic. Of course, a combination of these two approaches could be used.

Moreover, certain embodiments can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “substantially”, “essentially”, “approximately”, “about” or any other version thereof, are defined as “being close to” as understood by one of ordinary skill in the art, and where they used to describe numerically measurable items, the term is defined to mean within 15% unless otherwise stated. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method of voice recognition comprising:
receiving an audio signal
generating a sequence of frames of the audio signal;
transforming each frame of the audio signal into a set of narrow band feature vectors using a narrow passband;
coupling the narrow band feature vectors to a speech model;
determining whether the audio signal is a wide band signal; and
when the audio signal is determined to be a wide band signal,
generating for each frame a band energy parameter of each of one or more passbands that are outside the narrow passband, and
coupling the one or more band energy parameters to the speech model.

2. The method according to claim 1, wherein transforming the audio signal comprises performing a cepstrum transform.

3. The method according to claim 2, wherein transforming the audio signal comprises performing a mel frequency cepstrum transform.

4. The method according to claim 1, wherein determining whether the audio signal is a wide band signal comprises determining whether an amount of energy that is outside the narrow passband passes a threshold test

5. The method according to claim 4, wherein determining whether the audio signal is a wide band signal comprises:
determining an energy value for one or more frequency components of each frame of the audio signal at frequencies outside the narrow band; and
determining whether a time average of the one or more energy values exceeds a threshold.

6. The method according to claim 1, wherein determining whether the audio signal is a wide band signal comprises analyzing information about a system that is supplying the audio signal.

7. The method according to claim 1, wherein generating for each frame a band energy parameter of each of one or more passbands comprises determining log(Eᵣᵢ/E) for each passband, wherein i is a passband index, Eᵣ is a relative energy of the passband, and E is an energy of the frame.

8. The method according to claim 7, wherein determining whether the audio signal is a wide band signal comprises analyzing the one or more band energy parameters.

9. The method according to claim 1, wherein the narrowband is from approximately 300 Hz to 3200 Hz

10. The method according to claim 5, wherein there is one passband having center frequency below 300 Hz and two passbands having center frequencies above 3200 Hz.

11. The method according to claim 1, wherein the speech model is an HMM speech model trained with wide band cepstrum feature vectors derived from a wide band source and also trained with narrow band cepstrum feature vectors combined with band energy parameters that are derived from the wide band source.

12. An apparatus for speech recognition, comprising:
a framing function that generates a sequence of frames from a received audio signal;
a transformation function coupled to the framing function that transforms each frame of the audio signal into a set of narrow band feature vectors using a narrow passband;
a speech model that is coupled to the transformation function for determining a most likely utterance represented by the received signal;
a wide band detector coupled to the transformation function that determines whether the audio signal is a wide band signal;
an out of band transform function that generates for each frame a band energy parameter of each of one or more passbands that are outside the narrow passband; and
a switch that couples the one or more energy parameters to the speech model when the audio signal is determined to be a wide band signal.

13. The method according to claim 12, wherein the transformation function performs a cepstrum transform.

14. The method according to claim 12, wherein the wide band detector determines whether the audio signal is a wide band signal based on whether an amount of energy that is outside the narrow passband passes a threshold test.

15. The method according to claim 12, wherein determining whether the audio signal is a wide band signal comprises analyzing information about a system that is supplying the audio signal.

16. The method according to claim 12, wherein the out of band transform function determines log(Eᵣᵢ/E) for each passband, wherein i is a passband index, Eᵣ is a relative energy of the passband, and E is an energy of the frame.

17. The method according to claim 12, wherein the narrowband is from approximately 300 Hz to 3200 Hz.

18. The method according to claim 12, wherein the speech model is an HMM speech model trained with wide band cepstrum feature vectors derived from a wide band source and also trained with narrow band cepstrum feature vectors combined with band energy parameters that are derived from the wide band source.
